(19) United States
(12) Patent Application Publication
(10) Pub. No.: US 2005/0078918 A1
(43) Pub. Date: Apr. 14, 2005

(54) Line-mounted mini node RF-to-optical converter

(75) Inventor: Jon-En Wang, Chandler, AZ (US)

Correspondence Address: PCT International, Inc., 1715 W. Sunrise Blvd., Gilbert, AZ, 85233, US

(73) Assignee: PCT International, Inc., Gilbert, AZ (US)

(21) Appl. No.: 10/434,635

(22) Filed: May 12, 2003

(51) Int. Cl. G02B 6/36

(52) U.S. Cl. 385/92

(57) ABSTRACT

The present invention is a line-mounted electronic device which converts an RF-electrical coaxial cable component tap to include optical transmitter and receiver capability while maintaining RF functionality. Invention retrofits to the baseplate of an existing circuit component tap without further modification to other in-place circuit components.

### BACKGROUND OF INVENTION

The present invention is related to coaxial cable communications systems that comprise Radio Frequency (RF) circuits and components. Examples of such systems provide telephony, data, and video services to client-users as businesses, residences, educational, and governmental facilities, among other client types.

### BRIEF SUMMARY OF INVENTION

The present invention, line-mounted electronic device, retrofits to an in-place RF tap on an existing coaxial cable circuit and converts that component in such a way as to provide optical transmitter/receiver functions, along with maintaining RF-electrical capability.

### BRIEF DESCRIPTION OF DRAWINGS

FIG. 1 shows an example RF tap circuit component composed of faceplate and baseplate.

FIG. 2 shows the Line-mounted Mini Node RF-to-Optical Converter.

FIG. 3 shows the pre-assembled arrangement of conversion components.

FIG. 4 shows the final assemblage of the conversion components.

FIG. 5 shows the circuit schematic of the line-mounted mini node converter.

An assemblage of electronic components, the Line-mounted Mini Node RF-to-Optic Converter comprises optical transmitter and receiver functions and RF input and output circuit capabilities. Unique feature: Both Optic and RF functionalities are, therefore, collocated within a single housing. As an improvement over prior art: This invention can be retrofitted to an existing, in-place RF tap to provide fiber optic functionality while requiring no further modification to other, in-place devices on circuit such as taps, splitters, power inserters, and directional couplers.

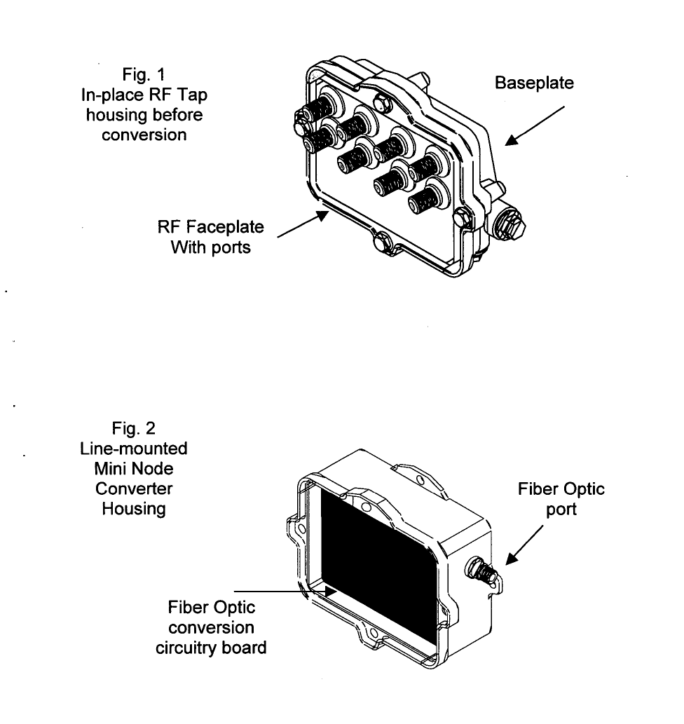

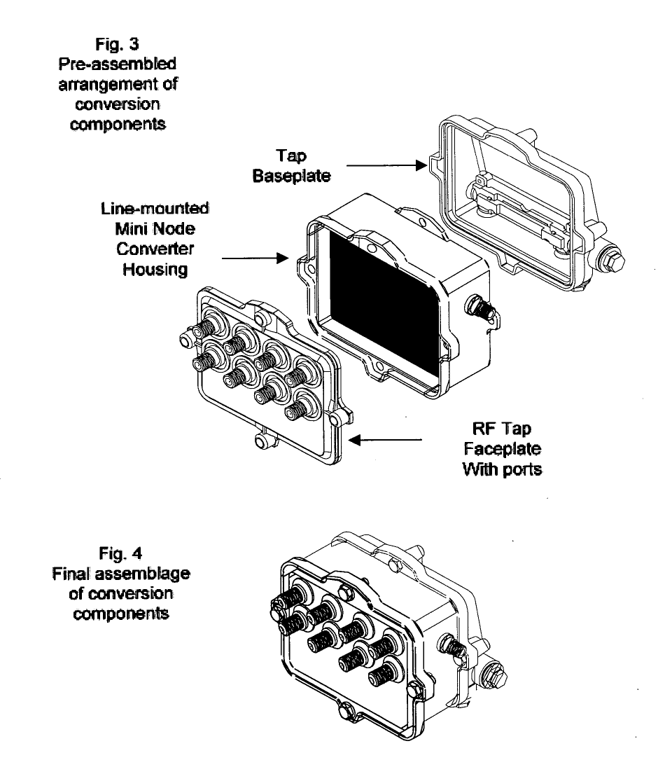

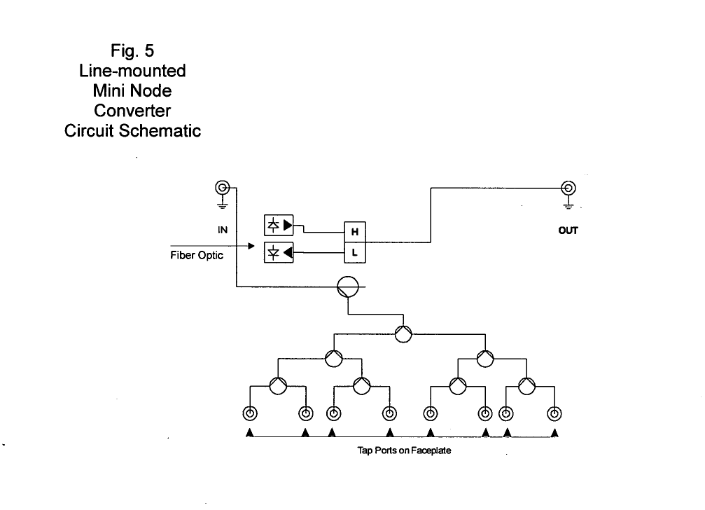

To install, an in-place tap, as illustrated by FIG. 1, is first selected and its faceplate is removed, leaving its baseplate in place. The Line-mounted Mini Node RF-to-Optical Converter (FIG. 2) is then retrofitted to the tap's baseplate. Completing the assemblage, the tap's faceplate is, next, mounted onto the mini node's housing, (reference FIG. 3). The final assemblage is, therefore, complete as shown in FIG. 4. Regarding its electronic functionality of components, FIG. 5, a schematic of the Line-mounted Mini Node RF-to-Optical Converter, is provided.

In one optional configuration, the invention may function as an optical receiver, only, as well as providing RF-electrical circuitry to that segment of the converted circuit. As an alternate option, the invention can function as an optical transmitter, only, as well as providing RF-electrical circuitry to that segment of the converted circuit.

1. What I claim is an electrical-to-optical transmitter and receiver whose utility is unique in that it can be retrofitted to a coaxial cable system without other modification from RF electrical to optical transmission utilizing the existing housings available to that system that were previously used for passive (non-power using) devices, such as taps, splitters, power inserters, and directional couplers. This device derives power from either the existing line or optionally from an external power supply where sufficient powering is not possible.
As a sub-set of claim A, I claim an optical receiver only to electrical transmitter only whose utility is used in applications of transmitting the downstream only portion of the transmission to a smaller segment of the network for various technical applications while optionally interrupting or not interrupting the existing flow of signals in either direction except for that portion which the device is directed to interrupt:
As a sub-set of claim A, I claim an optical transmitter from electrical receiver only whose utility is used in applications of transmitting the upstream or reverse only portion of the transmission from a smaller segment of the network for various technical applications while optionally interrupting or not interrupting the existing flow of signals in either direction except for that portion which the device is directed to interrupt.
